(19) United States
(12) Patent Application Publication
(10) Pub. No.: US 2016/0017997 A1
(43) Pub. Date: Jan. 21, 2016

(54) SELF-CENTERING SERVO PISTON

(71) Applicant: Danfoss Power Solutions Inc., Ames, IA (US)

(72) Inventors: Jaromir Tvaruzek, Ames, IA (US); Vince Ewald, Ames, IA (US); Michael J. Romey, Ames, IA (US); Charlie Dvorak, Ames, IA (US)

(21) Appl. No.: 14/333,948

(22) Filed: Jul. 17, 2014

(51) Int. Cl. F16J 1/08; F16J 9/26

(52) U.S. Cl. CPC F16J 1/08; F16J 9/26

(57) ABSTRACT

A servo piston having an elongated member with a first end and a second end. The second end has a servo piston head disposed within a servo piston bore. The servo piston head has at least two grooves disposed about an outer edge of the servo piston head. At last one sealing ring is received within each groove. The use of rings in at least two grooves reduces side/transversal vibration and the servo bore load. At the same time, the space between the two grooves creates a pressurized oil squeeze film between the servo piston head and servo piston bore, sealed by the rings, which provides both a sealing and damping function at the same time.

### BACKGROUND OF THE INVENTION

This invention is directed to a servo piston and more particularly a servo piston having non-axial translation movement.

Servo pistons are known in the art and are used with different machines where position of a part having rotational movement is driven by a servo piston rod where one end is connected to a driven part and a second end is inside of a servo piston bore where fluid pressure is used to control movement. Current servo pistons 2, as shown in FIG. 1, have one or more rings 4 in a groove 6, located at the servo piston head 8.

While the non-axial translation movement is small (±2° angle), the movement induces a side load which contributes to wear on the servo bore. Use of a single ring requires higher contact pressure to ensure a sealing function. Use of more than one ring in a single groove helps to reduce the need for high contact pressure but creates the disadvantage of the highest contact pressure at the last sealing ring from the servo pressure. Therefore, a need exists in the art for a servo piston that addresses these deficiencies.

An objective of the present invention is to provide a servo piston that reduces side/transversal vibration and servo bore load.

Another objective of the present invention is to provide a servo piston having multiple servo piston head grooves and rings that seal and dampen vibration at the same time.

These and other objectives will be apparent to those skilled in the art based upon the following written description, drawings and claims.

### SUMMARY OF THE INVENTION

A servo piston having an elongated member with a first end and a second end. The second end has a servo piston head disposed within a servo piston bore. The servo piston head has at least two grooves disposed about an outer edge of the servo piston head. At last one sealing ring is received within each groove. The use of rings in at least two grooves reduces side/transversal vibration and the servo bore load. At the same time, the space between the two grooves creates a pressurized oil squeeze film between the servo piston head and servo piston bore, sealed by the rings, which provides both a sealing and damping function at the same time.

### BRIEF DESCRIPTION OF THE DRAWINGS

FIG. 1 is a partial side view of a prior art servo piston head;

FIG. 2 is a side view of a servo piston head; and

FIG. 3 is a partial side view of a servo piston head.

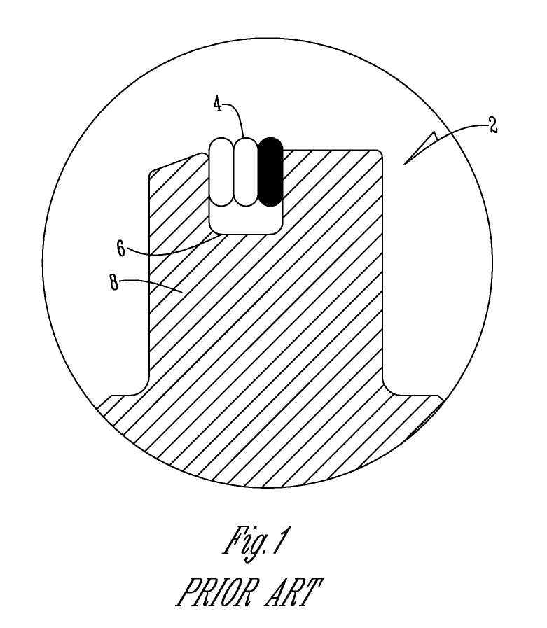

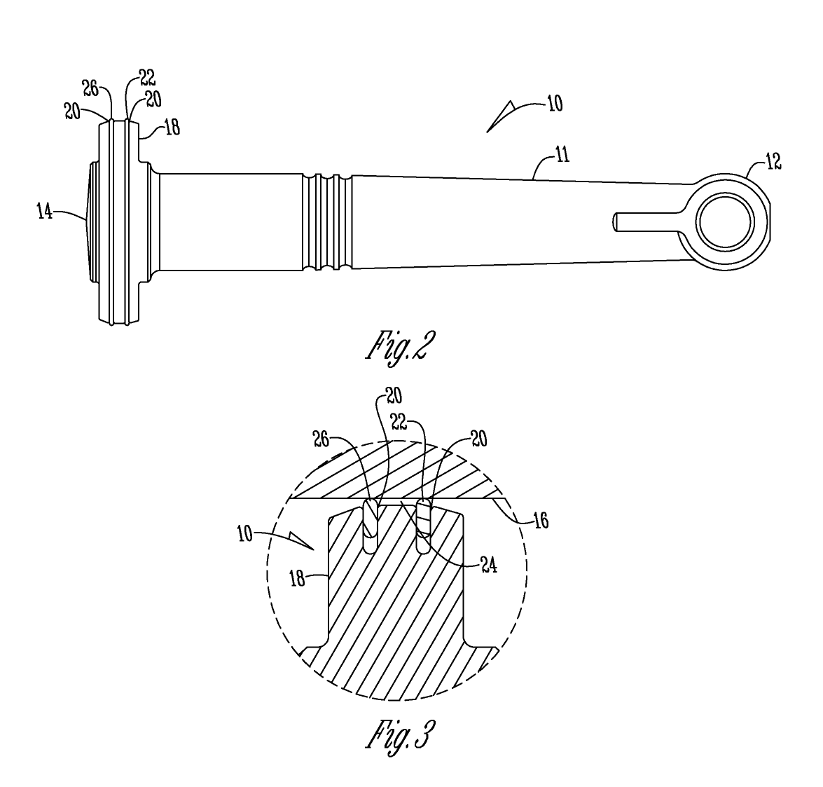

### DETAILED DESCRIPTION OF THE PREFERRED EMBODIMENTS

Referring to the Figures, a servo piston 10 has an elongated member 11 having a first end 12 connected to a driven part (not shown) and a second end 14 disposed within a servo piston bore 16 where fluid pressure is used to control movement.

The second end 14 has a servo piston head 18 that has an arcuate or spherical shape to allow non-axial translation movement without a risk of edge contact. The servo piston head 18 has at least two grooves 20 that receive at least one sealing ring 22 each. The sealing ring 22 is made of any material and preferably is made of a soft material such as ductile or grey iron. The center of the spherical contact surface is the middle between the two rings 22.

The use of two or more rings 22 in two or more grooves 20 results in each ring being ideally balanced which reduces contact load and significantly reduces wear of the servo bore 16. In addition, the space 24 between the two rings 22 sees lower pressure as servo pressure but higher than case pressure. As a result, in case a small clearance exists between the servo piston head 18 and the servo piston bore 16 a damper of any side/transversal vibration is created. Also, an oil squeeze film between the rings 22 reduces heavier mechanical contact between the servo piston head 18 and the servo piston bore 16.

What is claimed is:

1. The servo piston, comprising:
an elongated member having a first end and a second end;
a servo piston head at the second end disposed within a servo piston bore;
at least two grooves disposed around the servo piston head; and
at least one sealing ring received within each groove.

2. The piston of claim 1 wherein the sealing ring is made of a material selected from a group consisting of ductile and grey iron.

3. The piston of claim 1 wherein the servo piston head has a spherical shape.

4. The piston of claim 1 wherein the space between the at least two grooves creates a pressurized oil squeeze film between the servo piston head and the servo piston bore.
